(19) United States
(12) Patent Application Publication
(10) Pub. No.: US 2026/0149180 A1
(43) Pub. Date: May 28, 2026

(54) APPARATUSES, SYSTEMS AND METHODS OF RADIATING AND RECEIVING ELECTROMAGNETIC WAVES

(71) Applicant: HUAWEI TECHNOLOGIES CO., LTD., Shenzhen (CN)

(72) Inventors: Mohammad Mazaheri, Ottawa (CA); Hari Krishna Pothula, Stittsville (CA); David Neal Wessel, Ottawa (CA)

(21) Appl. No.: 18/963,031

(22) Filed: Nov. 27, 2024

(51) Int. Cl. H01Q 13/00

(52) U.S. Cl. CPC H01Q 13/00

(57) ABSTRACT

The apparatus includes a feed network arranged in a hierarchical configuration, including a series of junctions, each with one first-end section and two second-end sections. Within these junctions, at least one equal power splitter and at least one unequal power splitter are positioned to divide or combine electromagnetic waves, enabling customized power splitting ratios. Methods of radiating and receiving electromagnetic waves with the apparatus and systems including the apparatus are also described.

### TECHNICAL FIELD

The present disclosure relates to apparatuses, systems, and methods of radiating and receiving electromagnetic waves, particularly to waveguide antenna apparatuses featuring a feed network in a hierarchical configuration that allows for customizable power distribution.

### BACKGROUND

In recent years, the demand for faster and more reliable wireless communications has driven advances in a number of technologies. Millimeter wave (mmWave) networks, operating in the 24 GHz to 100 GHz frequency range, have emerged as a notable solution capable of delivering high data rates and low latency. Due to the large bandwidth available at mmWave frequencies, these networks are suitable for applications requiring high throughput, such as those envisioned in 5G and future wireless communication systems.

Waveguide technology is commonly used in mmWave applications due to its ability to handle high power levels and its low insertion loss characteristics. While traditional PCB-based systems are prevalent at lower RF frequencies, the signal losses associated with PCB technology become more significant at mmWave frequencies, making waveguides an alternative for signal transmission. Certain waveguide configurations, such as square waveguides, are capable of supporting two orthogonal modes, which can enable higher data rates in mmWave systems.

### SUMMARY

According to a first aspect, there is provided a waveguide antenna apparatus, comprising: a feed network configured to divide a first-end electromagnetic wave into wave fractions in a radiation direction for radiating in at least one of vertical and horizontal polarization modes, or to combine a plurality of second-end electromagnetic waves into a single wave in a reception direction opposite to the radiation direction, the feed network including: a plurality of junctions, each having one first-end section and two second-end sections; at least one equal power splitter positioned at one or more of the plurality of junctions, each of the at least one equal power splitter structured being symmetrically to divide a radiation electromagnetic wave arriving from its corresponding first-end section into two equally divided waves, or to combine two reception electromagnetic waves arriving from its corresponding second-end sections; and at least one unequal power splitter positioned at the remaining junctions, each of the at least one unequal power splitter being asymmetrically structured to divide a radiation electromagnetic wave arriving from its corresponding first-end section into two unequally divided waves, or combine two reception electromagnetic waves arriving from its corresponding second-end sections.

In some implementations, the apparatus may further comprise a first-end aperture configured to feed or receive a the first-end electromagnetic wave to or from an orthomode transducer (OMT); a plurality of second-end apertures, each configured to radiate or receive a one of the plurality of second-end electromagnetic waves.

In some implementations, the feed network may have a square cross-section configured to support a transmission of dual polarization modes.

In some implementations, the plurality of second-end apertures may be distributed along a straight line.

In some implementations, each of the at least one equal power splitter may comprise a horizontal plate and a vertical plate perpendicular to the horizontal plate, forming a cross-shaped cross section, the horizontal plate may be divided by the vertical plate into a left part and a right part of a same length, and wherein an overlap between the horizontal plate and the vertical plate forms an elongate block that is coaxially aligned with a longitudinal axis of the first-end section.

In some implementations, the first-end section may have a square-shaped cross section, wherein the horizontal plate is parallel to two opposite surfaces of the first-end section, and the left and right parts of the horizontal plate may extend into the two second-end sections.

In some implementations, each of the plurality of junctions in the feed network may be shaped as a T-shaped manifold, and the two second-end sections may be coaxially oriented with each other and are perpendicular to the first-end section.

In some implementations, an iris may be positioned in the first-end section.

In some implementations, each of the at least one unequal power splitter may comprise a horizontal plate and a vertical plate perpendicular to the horizontal plate, the horizontal plate may be positioned on at least one side of the vertical plate, and an overlap between the horizontal plate and the vertical plate may form an elongate block that is parallel to the longitudinal axis of the first-end section.

In some implementations, the first-end section may have a square-shaped cross section, the horizontal plate may be parallel to two opposite surfaces of the first-end section, and the horizontal plate may extend into at least one of the two second-end sections.

In some implementations, the horizontal plate may be divided by the vertical plate into a left part and a right part of different lengths.

In some implementations, the overlap between the horizontal plate and the vertical plate may be offset from the longitudinal axis of the first-end section.

In some implementations, each of the plurality of junctions in the feed network may be shaped as a T-shaped manifold, and the two second-end sections may be coaxially oriented with each other and are perpendicular to the first-end section.

In some implementations, an iris may be positioned in the first-end section.

In some implementations, the feed network may be a tree structure and the plurality of junctions are provided at different stages of the tree structure, such that each of the wave fractions passes through at least three junctions before reaching the corresponding one of the plurality of second-end apertures.

In some implementations, at least one of the at least three junctions may be provided with an unequal power splitter.

In some implementations, the plurality of junctions, the at least one equal power splitter, and the at least one unequal power splitter may be integrally fabricated by three-dimensional (3D) printing.

In some implementations, the feed network may be made of a metallic material.

According to a second aspect, there is provided a method of radiating electromagnetic waves through a waveguide antenna apparatus, the method comprising: receiving a first-end electromagnetic wave at a first end of the waveguide antenna apparatus; directing the first-end electromagnetic wave into a feed network of the waveguide antenna apparatus, the feed network configured to divide the first-end electromagnetic wave into wave fractions in a radiation direction for radiating at a second end of the waveguide antenna apparatus, wherein the feed network comprises a plurality of junctions, each having one first-end section and two second-end sections; dividing the first-end electromagnetic wave into the wave fractions using at least one equal power splitter and at least one unequal power splitter, wherein the at least one equal power splitter is positioned at one or more of a plurality of junctions in the feed network and symmetrically structured to divide a radiation electromagnetic wave arriving from its corresponding first-end section into two equally divided waves, and wherein the at least one unequal power splitter is positioned at the remaining junctions and asymmetrically structured to divide a radiation electromagnetic wave arriving from its corresponding first-end section into two unequally divided waves; and directing each of the wave fractions to the second end of the waveguide antenna apparatus for radiation in at least one of vertical and horizontal polarization modes.

According to a third aspect, there is provided a method of receiving electromagnetic waves in a waveguide antenna apparatus, the method comprising: receiving a plurality of second-end electromagnetic waves at a second end of the waveguide antenna apparatus; directing the plurality of second-end electromagnetic waves into a feed network of the waveguide antenna apparatus, the feed network configured to combine the plurality of second-end electromagnetic waves into a single wave in a reception direction at a first end of the waveguide antenna apparatus, wherein the feed network comprises a plurality of junctions, each having one first-end section and two second-end sections; combining the plurality of second-end electromagnetic waves into the single wave using at least one equal power splitter and at least one unequal power splitter, wherein the at least one equal power splitter is positioned at one or more of a plurality of junctions in the feed network and symmetrically structured to combine two reception electromagnetic waves arriving from its corresponding second-end sections; and wherein the at least one unequal power splitter is positioned at the remaining junctions and asymmetrically structured to combine two reception electromagnetic waves arriving from its corresponding second-end sections; and directing the combined single wave to the first end of the antenna waveguide.

According to a fourth aspect, there is provided a communication system comprising: a waveguide antenna apparatus described herein, including a plurality of feed networks stacked with each other; a plurality of orthomode transducers (OMTs), each connected to a respective one of the plurality of feed networks, wherein each of the plurality of OMTs is configured to receive and transmit dual orthogonally polarized electromagnetic waves; and a pair of beamforming devices, each having a corresponding number of outlets coupled to the plurality of OMTs to supply the radiation electromagnetic wave of a specific polarization to the plurality of OMTs.

According to the implementations of the present disclosure, the described feed network offers several advantages for high-frequency applications. The tree structure of the feed network, with its series of multiple junctions incorporating both equal and unequal power splitters, enables precise control over power distribution to each output aperture, enhancing flexibility and adaptability for various antenna configurations. This combination of structural flexibility makes the feed network particularly advantageous for use in advanced communication systems.

This summary does not necessarily describe the entire scope of all aspects. Other aspects, features and advantages will be apparent to those of ordinary skill in the art upon review of the following description of specific embodiments.

### BRIEF DESCRIPTION OF THE FIGURES

In the accompanying drawings, which illustrate one or more example embodiments:

FIG. 1 is a block diagram of a system for handling dual-mode electromagnetic waves, according to an example embodiment.

FIG. 2 is an example feed network configured to distribute electromagnetic waves across multiple stages of junctions, according to an example embodiment.

FIG. 3 is a cross-sectional view of the tunnel within the feed network, according to an example embodiment.

FIG. 4 is a graph illustrating the design considerations for selecting the cross-sectional dimension of the waveguide tunnel in the feed network, according to an example embodiment.

FIG. 5 is a design geometry of adjacent second-end apertures within the feed network, according to an example embodiment.

FIG. 6 is an example of a junction within the feed network shown in FIG. 2.

FIG. 7 is an illustration of an equal power splitter as viewed along the direction of the first-end port shown in FIG. 6.

FIG. 8 is a cross-sectional view of the junction shown in FIG. 6.

FIGS. 9 and 10 are graphs illustrating the performance of the equal power splitter shown in FIGS. 6-8, for vertical and horizontal polarizations, respectively.

FIG. 11 is a junction in which an unequal power splitter is positioned, according to an example embodiment.

FIGS. 12 and 13 depict graphs illustrating the performance of the unequal power splitter shown in FIG. 11, for vertical and horizontal polarizations, respectively.

FIG. 14 is one of the junctions of the feed network shown in FIG. 2, in which an equal power splitter is in position.

FIGS. 15 and 16 are graphs illustrating the performance of the splitter positioned in the junction shown in FIG. 14, for vertical and horizontal polarizations, respectively.

FIG. 17 is one of the junctions of the feed network shown in FIG. 2, in which an equal power splitter is in position.

FIGS. 18 and 19 are graphs illustrating the performance of the splitter positioned in the junction shown in FIG. 17, for vertical and horizontal polarizations, respectively.

FIG. 20 is one of the junctions of the feed network shown in FIG. 2, in which an equal power splitter is in position.

FIGS. 21 and 22 are graphs illustrating the performance of the splitter positioned in the junction shown in FIG. 20, for vertical and horizontal polarizations, respectively.

FIG. 23 is one of the junctions of the feed network shown in FIG. 2, in which an equal power splitter is in position.

FIGS. 24 and 25 are graphs illustrating the performance of the splitter positioned in the junction shown in FIG. 23, for vertical and horizontal polarizations, respectively.

FIG. 26 is one of the junctions of the feed network shown in FIG. 2, in which an unequal power splitter is in position.

FIGS. 27 and 28 are graphs illustrating the performance of the splitter positioned in the junction shown in FIG. 26, for vertical and horizontal polarizations, respectively.

FIG. 29 is one of the junctions of the feed network shown in FIG. 2, in which an unequal power splitter is in position.

FIGS. 30 and 31 are graphs illustrating the performance of the splitter positioned in the junction shown in FIG. 29, for vertical and horizontal polarizations, respectively.

### DETAILED DESCRIPTION

In certain high-throughput mmWave applications, it can be advantageous to support two orthogonal linear polarizations within a waveguide structure. This dual-mode capability allows one waveguide to handle multiple signal paths, which can increase data transmission capacity. Square waveguides, among other configurations, can support two orthogonal modes, allowing both polarizations to use a common guiding structure and antenna system, thereby optimising the use of available space and resources.

Air-filled square waveguides can offer reduced transmission losses and simplified manufacturing processes. Compared with PCB-based solutions, air-filled waveguides can offer different performance characteristics in terms of signal loss, contributing to signal integrity over longer distances. The square waveguide structure is therefore an option to consider for the design of feed networks in mmWave systems due to its support for dual-mode operation.

The feed network distributes power to each antenna element, typically through the use of power splitters. The present disclosure involves the use of a power splitter capable of providing arbitrary power ratios for two orthogonal modes within a square waveguide. This approach enables precise control of power distribution while remaining compatible with current manufacturing processes.

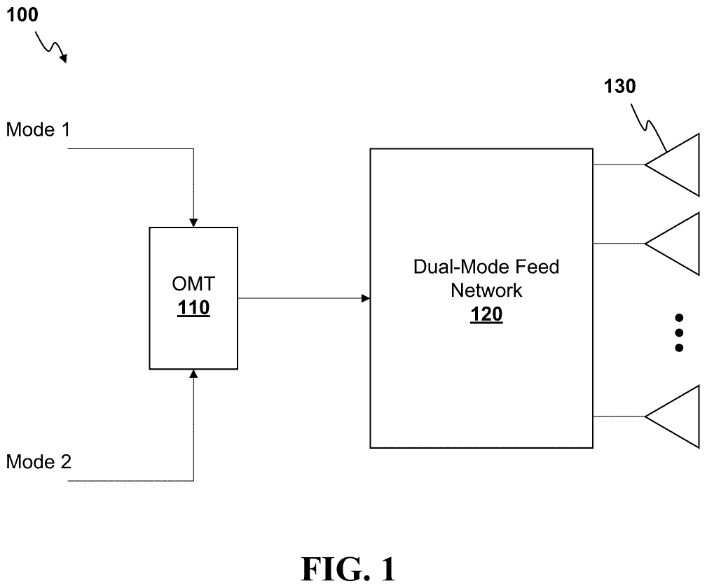

FIG. 1 illustrates a block diagram of a system 100 for handling dual-mode electromagnetic waves. The system 100 includes an orthomode transducer (OMT) 110, a dual-mode feed network 120 and a number of antenna elements 130.

In this configuration, the OMT 110 receives or transmits a first-end electromagnetic wave in two orthogonal modes, referred to as Mode 1 and Mode 2. The OMT 110 is connected to a first-end aperture of the feed network 120. The feed network 120 is configured to divide the incoming first-end electromagnetic wave into wave fractions in a radiation direction and distribute them to the second-end apertures connected to the antenna elements 130 supporting the dual modes. These second-end apertures are capable of radiating or receiving electromagnetic waves in both vertical and horizontal polarizations.

Alternatively, in a reception direction (from right to left in FIG. 1) opposite to the radiation direction, the feed network 120 combines the electromagnetic waves received at the second-end apertures into a single wave which is then fed to the OMT 110. The design allows for the efficient distribution or combination of electromagnetic waves across multiple antenna elements 130, enhancing the system's ability to handle multiple polarizations and support high throughput mmWave applications.

While the OMT 110 facilitates the handling of dual-mode electromagnetic waves by separating or combining orthogonal polarizations, the feed network 120 can still effectively operate as a single-mode network when only a single polarization or mode is required. In this configuration, the feed network 120 can distribute the power of electromagnetic waves in a single mode to the plurality of second-end apertures, allowing efficient power division or combination even without the use of dual-mode capabilities. A pair of beamforming devices (not shown) may be provided to be coupled to the OMT 110, each configured to supply electromagnetic waves of a specific polarization to the OMT 110.

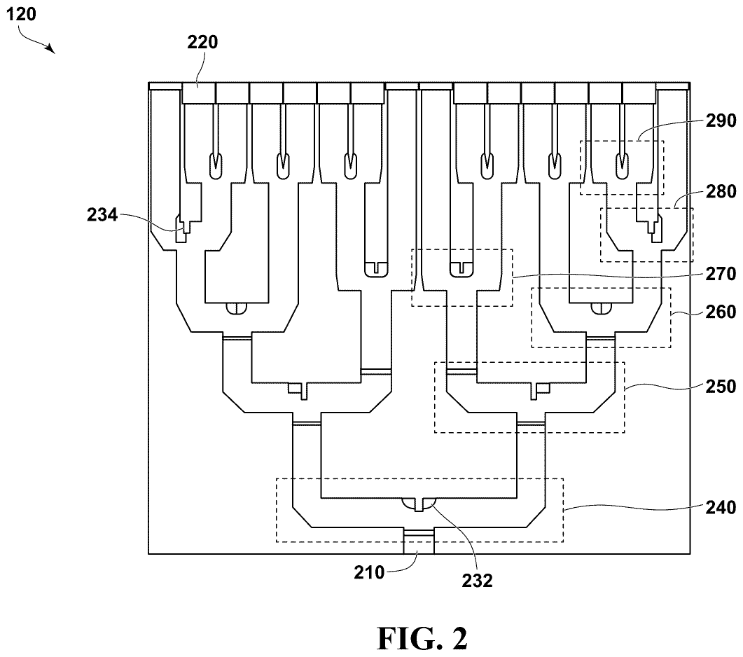

FIG. 2 illustrates an example feed network 120, configured to distribute electromagnetic waves across multiple stages of junctions. The feed network 120 includes a plurality of junctions, where each junction is structured as a manifold with one first-end section and two second-end sections. This configuration enables the network to split or combine electromagnetic waves efficiently based on the specific power requirements at each stage.

The feed network 120 is shown to include both equal power splitters and unequal power splitters across various junctions. For example, at junctions such as a first junction 240, a third junction 260, a fourth junction 270, and a sixth junction 290, an equal power splitter 232 is positioned to divide an incoming electromagnetic wave from the corresponding first-end port into two equally divided radiation waves, or conversely, to combine two reception electromagnetic waves arriving from the corresponding second-end sections into a single wave. This configuration ensures a balanced distribution of power where equal division is desired.

At other junctions, such as a second junction 250 and a fifth junction 280, an unequal power splitter 234 is positioned. The unequal power splitter 234 is structured to divide the incoming electromagnetic wave into two unequally divided waves, or to combine two incoming waves arriving from the corresponding second-end sections into a single wave. This configuration allows the feed network 120 to achieve customized power ratios depending on the specific needs of the connected antenna elements.

In a radiation direction, the feed network 120 begins at a first-end aperture 210 and extends through multiple stages of junctions, ending at a plurality of second-end apertures 220. The second-end apertures 220 may be distributed along a line, as shown, and each may be used as a dual-mode antenna as described in respect of FIG. 1. In this example, the junctions and power splitters are arranged in a hierarchical structure to ensure that the desired power division or combination is achieved at each stage.

While FIG. 2 illustrates the use of multiple equal power splitters and multiple unequal power splitters, it should be understood that the feed network 120 may also be configured with as few as one equal power splitter and as few as one unequal power splitter, depending on the application requirements. This flexible design allows the distribution pattern to be adjusted to accommodate different operational configurations.

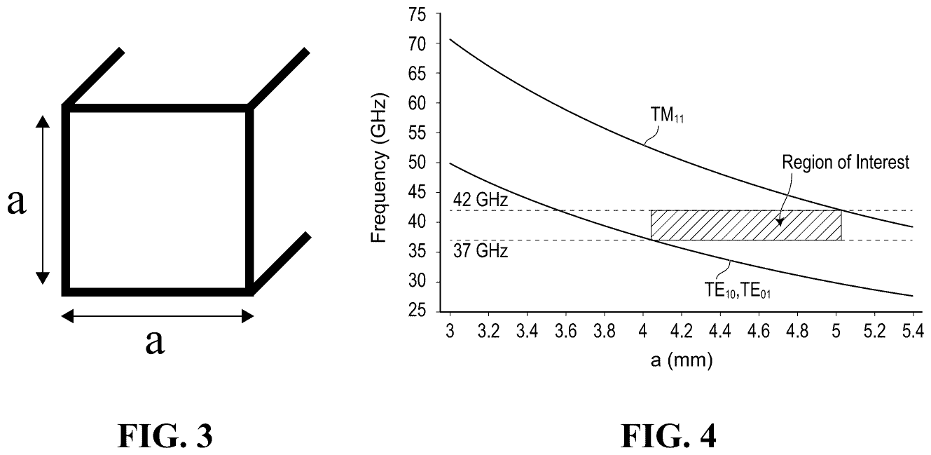

FIG. 3 shows a cross-sectional view of the tunnel within the feed network 120, illustrating the square cross-section with side length a. This square geometry supports dual-mode operation, allowing the feed network 120 to handle multiple signal paths within a compact structure.

The figure also includes an equation for calculating the cutoff frequency fₘₙ for specific modes, defined by the mode numbers m and n. The cutoff frequency fₘₙ is given by:

$${f}_{m n} = \frac{C}{2 a} \sqrt{{m}^{2} + {n}^{2}} \qquad ( 1 )$$

where C is the speed of light, a is the length of each side of the square cross-section, and m and n are mode indices indicating the number of half-wavelengths in the respective directions.

FIG. 4 illustrates the design considerations for selecting the cross-sectional dimension a of the waveguide tunnel in the feed network 120, based on the operational frequency range and the cutoff frequencies for specific waveguide modes. The graph shows the relationship between the frequency (in GHz) and the dimension a (in mm) for various modes within the waveguide. The operational frequency range of interest, between 37 GHz and 42 GHz, is highlighted in the shaded “Region of interest”.

In waveguide design, the cutoff frequency defines the lowest frequency at which a particular mode can propagate. Modes such as TE₁₀, TE₀₁, and TM₁₁ refer to specific field patterns of the electromagnetic waves within the waveguide:
TE Modes (Transverse Electric): For modes like TE₁₀ and TE₀₁, the electric field is purely transverse to the direction of propagation, with no longitudinal electric field component. These modes are often used for signal transmission in waveguides.
TM Modes (Transverse Magnetic): For modes like TM₁₁, the magnetic field is purely transverse, with no longitudinal magnetic field component.

The curves marked TE₁₀, TE₀₁ (lower curve) and TM₁₁ (upper curve) represent the cutoff frequencies for these modes based on the dimension a of the waveguide cross-section. The region below the TE₁₀ and TE₀₁ curves indicates that any frequency lower than the cutoff frequency for these modes would not propagate through the waveguide, as they would be below the threshold.

For the selected frequency range of 37 GHz to 42 GHZ, the analysis shows that the dimension a can range from approximately 4.1 mm to 5 mm. This range of values for a ensures that the waveguide supports the desired TE₁₀ and TE₀₁ modes within the specified frequency band, while excluding higher modes like TM₁₁, which may interfere with efficient signal transmission.

The “region of interest” in the shaded area represents the optimal range for dimension a, where the area is ensured to be above modes TE₁₀ and TE₀₁ and below mode TM₁₁ falls within the frequency band. This design principle ensures efficient transmission by confining the propagation to the desired modes and maintaining signal integrity across the feed network.

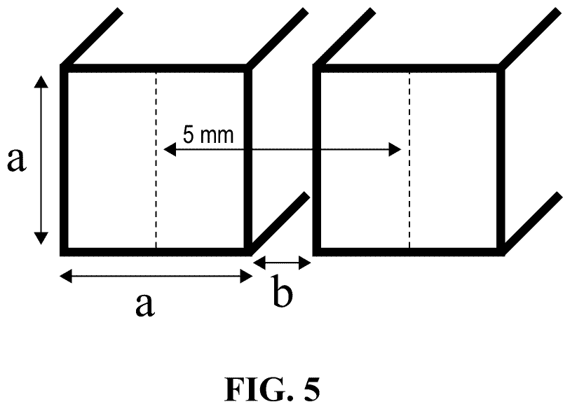

FIG. 5 illustrates the design geometry of adjacent second-end apertures within the feed network, focusing on the dimensions required to achieve optimal performance and manufacturability. In this design, the width a of each aperture and the spacing b between adjacent apertures should satisfy specific constraints to maintain effective power distribution and impedance matching.

The combined width of a+b=5 mm is selected to maintain compactness while supporting the required operational frequencies. To meet manufacturing constraints, the minimum spacing b is set at 0.3 mm. Consequently, the maximum possible width a for each aperture is limited to 4.7 mm. This constraint ensures that the maximum size of each aperture remains at 4.7 mm.

For the feed network in this embodiment, a value of a=4.4 mm may be chosen for at least two reasons:
Reducing the Risk of Fabrication Error: By selecting a slightly smaller dimension for a, the design minimizes the likelihood of manufacturing inaccuracies that may arise from operating at the maximum allowable width.
Enhanced Output Matching: By tapering the aperture dimension from 4.7 mm to 4.4 mm at the output, the design achieves better impedance matching, which is beneficial for reducing reflection and ensuring efficient signal transmission.

This design approach allows the feed network to achieve both reliable manufacturability and improved performance by balancing the geometry of the adjacent second-end apertures.

Although the feed network in this example has a generally square cross-section to support dual-mode operation, it should be noted that the cross-sectional shape may vary. For instance, the cross-section may have rounded or chamfered edges, and it need not be a perfect square. Variations in cross-sectional shape are permissible as long as they do not significantly affect the functionality of the splitter or the intended operation of the feed network. Additionally, the feed network has multiple tunnels between the splitters, with turns that can be chamfered or rounded to facilitate impedance matching when needed.

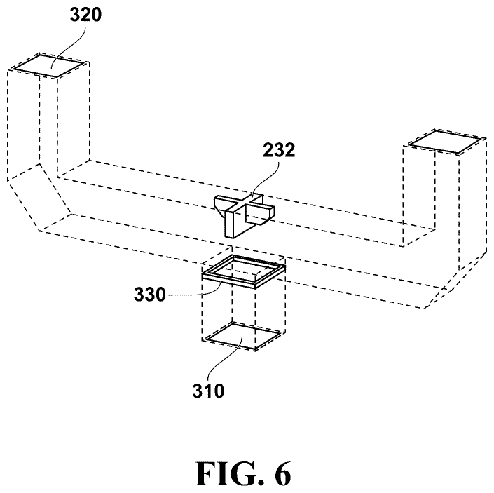

FIG. 6 illustrates an example of a junction within the feed network 120, as depicted in FIG. 2, which incorporates an equal power splitter 232. This junction, forming part of the feed network 120, includes an first-end port 310 and two second-end ports 320. When an electromagnetic wave propagates through the feed network 120 in the radiation direction, it enters the junction through the first-end port 310. The equal power splitter 232 then divides the incoming wave into two equal portions in terms of power, which exit the junction via the second-end ports 320. Conversely, when two electromagnetic waves propagate in the reception direction, entering the junction from the second-end ports 320, the equal power splitter 232 combines these waves, and the resulting combined wave exits the junction through the first-end port 310. Additionally, an iris 330 may be provided at the first-end port 310 to facilitate impedance matching, thereby enhancing signal integrity.

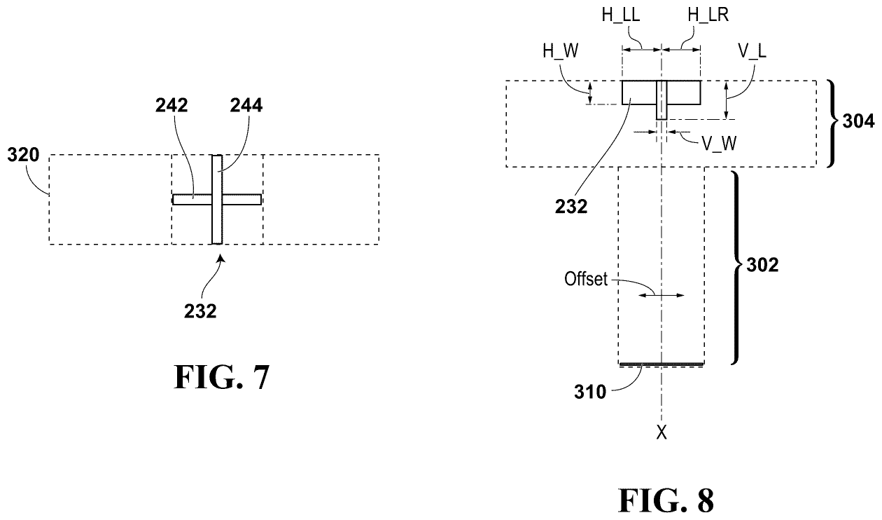

FIG. 7 provides an illustration of the equal power splitter 232 as viewed along the direction of the first-end port 310, while FIG. 8 shows a cross-sectional view of the junction depicted in FIG. 6. In FIG. 8, the junction includes a first-end section 302, which connects to the first-end port 310, and two second-end sections 304, each connected to one of the second-end ports 320. The first-end section 302 may comprise or be structured as a straight tunnel aligned along a longitudinal axis X, which runs centrally through this section.

In the example depicted in FIG. 8, the junction has a T-shaped manifold configuration, with the two second-end sections 304 oriented coaxially and perpendicular to the first-end section 302. However, it should be understood that the junction's shape is not limited to this configuration. For example, the junction could be designed as a Y-shaped manifold, where the two second-end sections 304 extend at angles greater or smaller than 90 degrees relative to the X-axis. In some embodiments, the junction may also be asymmetrical, with the two second-end sections 304 extending from the X-axis at different angles. These variations in geometry allow for flexible design options depending on specific application requirements.

As illustrated in FIG. 7, the equal power splitter 232 includes a horizontal plate 242 and a vertical plate 244, positioned perpendicular to each other. Together, these plates form a cross-shaped cross-section when viewed along the X-axis. The horizontal plate 242 is divided into a left part and a right part by the vertical plate 244, with the left part having a length indicated by H_LL and the right part having a length indicated by H_LR, as shown in FIG. 8. For the equal power splitter configuration, the lengths of the left and right parts (H_LL and H_LR) are equal. The overlap between the horizontal plate 242 and the vertical plate 244 forms an elongate block that is coaxially aligned with the X-axis to facilitate symmetrical wave splitting. The equal power splitter 232 is oriented such that the horizontal plate 242 extends toward the second-end section 304 and the vertical plate 244 is parallel to two opposite walls of the first-end section 302 on the left and right sides as shown in FIGS. 7 and 8.

Referring to FIG. 8, the vertical plate 244 has a width V_W and a height V_L, while the horizontal plate 242 has a height H_W. The vertical plate 244 may be offset relative to the X-axis, although in the equal power splitter configuration shown, the offset is zero. The length ratio between the left (H_LL) and right (H_LR) parts of the horizontal plate 242 influences the horizontal polarization power ratio, while the offset of the vertical plate 244 influences the power ratio between the vertical and horizontal polarizations. All other parameters, such as the width and height of each plate, contribute to the impedance matching of the splitter. For instance, with the configuration values V_W=0.5 mm, V_L=2 mm, H_W=1.25 mm, H_LR=2 mm, H_LL=2 mm, and zero offset, the power ratio is 1:1 for both horizontal and vertical polarizations, ensuring equal power distribution across both polarizations.

The equal power splitter 232 shown in FIGS. 6-8 can be described as having a symmetrical structure. Specifically, the cross-section as viewed from the first-end port 310 is symmetrical with respect to a vertical plane dividing the left and right second-end sections. This symmetrical design ensures that the power of both horizontal and vertical polarization modes is equally split. However, it should be understood that the cross-shaped equal power splitter is merely an example; other shapes are available for equal power splitters. These include a vertical plate (without the use of a horizontal plate), a vertical ridge, or any structure-whether standalone or integrated with the junctions—that can divide power equally between horizontal and vertical polarization modes.

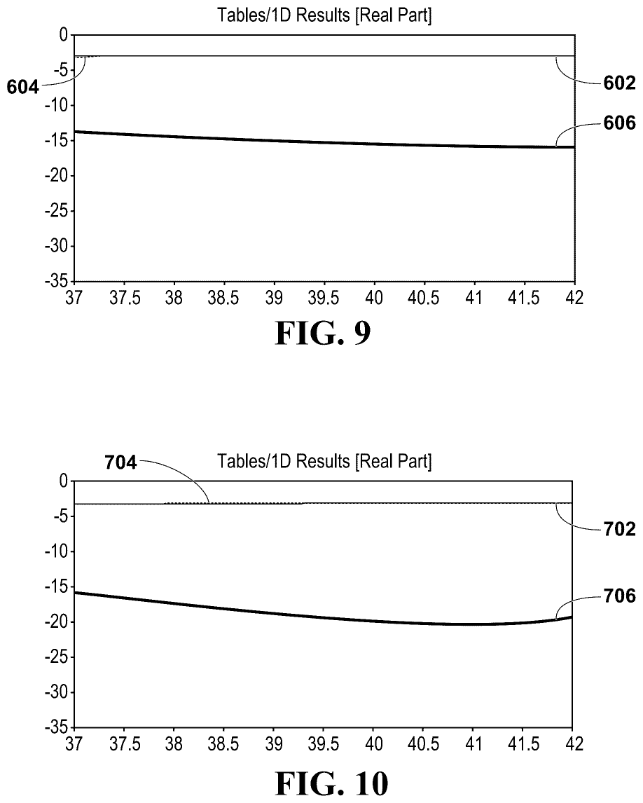

FIGS. 9 and 10 present simulation graphs illustrating the performance of the equal power splitter 232 as shown in FIGS. 6-8, for vertical and horizontal polarizations, respectively. In each figure, the vertical axis represents power attenuation in decibels relative to the incoming wave at the first-end port, while the horizontal axis represents frequency in GHz.

In FIG. 9, the power distribution between the left split wave (represented by curve 602) and the right split wave (represented by curve 604) is nearly identical for the vertical from the equal power splitter 232, exhibits a power attenuation of approximately 14 to 16 dB, as represented by curve 606.

Similarly, FIG. 10 shows that the power distribution between the left split wave (represented by curve 702) and the right split wave (represented by curve 704) is also nearly identical for the horizontal polarization. The returning wave for the horizontal polarization, reflected from the equal power splitter 232, is attenuated by approximately 15 to 20 dB, as represented by curve 706. These results demonstrate the equal power splitter's 232 effectiveness in providing consistent power distribution for both polarizations, while also ensuring significant attenuation of any reflected waves.

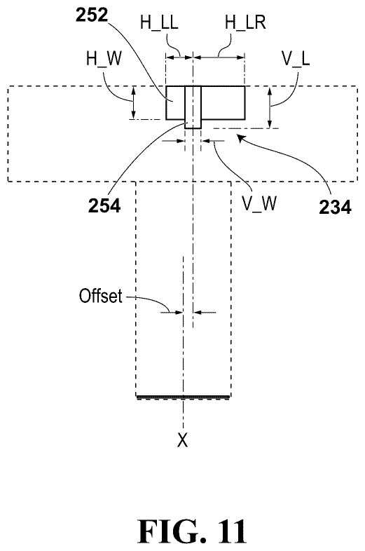

FIG. 11 illustrates a junction in which an unequal power splitter 234 is positioned. The unequal power splitter 234 also has a horizontal plate 252 and a vertical plate 254 like the equal power splitter 232. The difference lies in that the left part and the right part of the horizontal plate 252 have different lengths. The horizontal plate 252 is positioned on at least one side of the vertical plate 254, although in the example shown in FIG. 11 the horizontal plate 252 is on both sides of the vertical plate 254.

For example, in FIG. 11, the vertical plate 254 has a width V_W and a height V_L, while the horizontal plate 252 has a height H_W. The vertical plate 254 may be offset relative to the X-axis, as shown in FIG. 11 (with the offset being non-zero, the overlap between the horizontal plate 252 and the vertical plate 254 forms an elongate block that is parallel to the X-axis). The length ratio between the left (H_LL) and right (H_LR) parts of the horizontal plate 252 influences the horizontal polarization power ratio, while the offset of the vertical plate 254 influences the power ratio between the vertical and horizontal polarizations. All other parameters, such as the width and height of each plate, contribute to the impedance matching of the splitter. For instance, with the configuration values V_W=0.75, V_L=2, H_W=1.6, H_LR=2.4, H_LL=1.2, and 0.45 offset, the power ratio is 1.5:1 for both horizontal and vertical polarizations.

The unequal power splitter 234 shown in FIG. 11 can be described as having an asymmetrical structure. Specifically, the cross-section as viewed from the first-end port 310 is asymmetrical with respect to a vertical plane dividing the left and right second-end sections. This asymmetrical design ensures that the power of both horizontal and vertical polarization modes is unequally split.

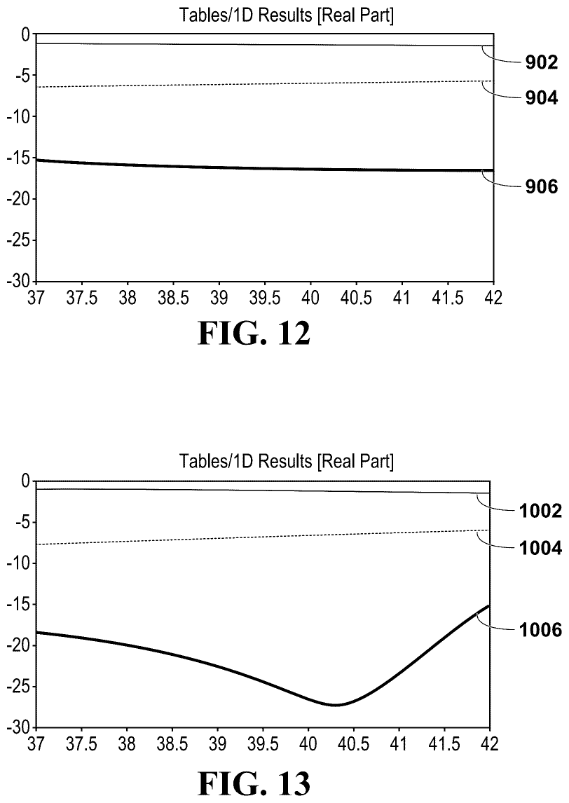

FIGS. 12 and 13 present simulation graphs illustrating the performance of the unequal power splitter 234 as shown in FIG. 11, for vertical and horizontal polarizations, respectively. In each figure, the vertical axis represents power attenuation in decibels relative to the incoming wave at the first-end port, while the horizontal axis represents frequency in GHz.

In FIG. 12, the power distribution between the left split wave (represented by curve 902) and the right split wave (represented by curve 904) is unbalanced for the vertical polarization. The left split wave experiences a power attenuation of approximately 1 to 2 dB, whereas the right split wave has a higher attenuation of approximately 5 to 7 dB. Additionally, the returning wave, which reflects back from the unequal power splitter 234, exhibits a power attenuation of approximately 15 to 17 dB, as represented by curve 906.

Similarly, FIG. 13 shows an unbalanced power distribution for the horizontal polarization, with the left split wave (represented by curve 1002) experiencing a power attenuation of about 1 to 2 dB, while the right split wave (represented by curve 1004) is attenuated by approximately 6 to 8 dB. The returning wave for the horizontal polarization, reflected from the unequal power splitter 234, is attenuated by approximately 15 to 27 dB, as represented by curve 1006. These results demonstrate the functionality of the unequal power splitter 234, which effectively achieves customized power ratios between the split waves for both vertical and horizontal polarizations, while also attenuating reflected waves significantly.

Referring again to FIG. 2, the example embodiment of the feed network 120 includes multiple stages of junctions, represented by junctions such as 240, 250, 260, 270, 280, and 290. In this configuration, certain junctions—such as 250 and 280—are equipped with unequal power splitters, while the remaining junctions use equal power splitters. This arrangement of mixed junctions, each incorporating a unique type of power splitter, allows for versatile control over power distribution within the feed network 120.

The structure of the feed network in this example enables an incoming electromagnetic wave at the first-end aperture 210 to be progressively divided into sixteen distinct waves by the time it reaches the second-end apertures 220 (or combining sixteen waves received at the second-end apertures 220 into one wave as it reaches the first-end aperture 210). Notably, the waves closer to the center of the feed network 120 tend to carry higher power levels, allowing for a controlled and optimized distribution of energy. The distribution pattern and power levels can be tailored according to the specific requirements of the application by varying the number of stages, the types of splitters, and the structural configurations of each splitter.

The design flexibility makes it possible to achieve virtually any desired power distribution by strategically selecting and configuring the stages and splitters within a feed network. Each splitter can have a unique structural configuration, enabling precise control over the division of power between output paths at each junction. In the subsequent sections, the performance characteristics of each type of splitter used in the example embodiment shown in FIG. 2 are described and analyzed, demonstrating how different splitter configurations impact the overall power distribution across the feed network 120.

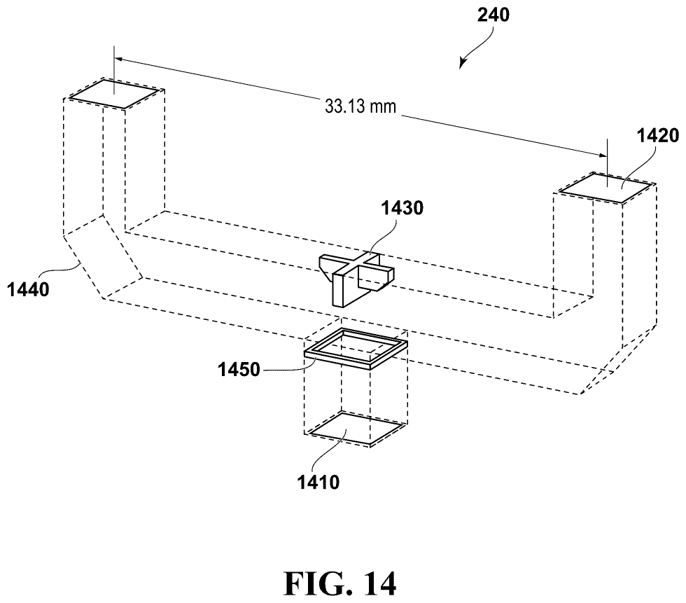

FIG. 14 illustrates the first junction 240 as the first stage (in the radiation direction) of the feed network 120 shown in FIG. 2. The first junction 240 is structured as a T-shaped manifold, featuring a first first-end port 1410 and two first second-end ports 1420. In this example, the distance between the centers of the two first second-end ports 1420 is 33.13 mm. Positioned within the first junction 240 is a first splitter 1430, configured as an equal power splitter. The overlap between the horizontal and vertical plates of the first splitter 1430 forms an elongate block, which faces the first first-end port 1410 and aligns coaxially with the longitudinal axis of the first-end section of the junction. The horizontal plate of the first splitter 1430 extends perpendicularly to the first-end section of the junction and is oriented to extend into the second-end section of the first junction 240. The vertical plate of the first splitter 1430, which is perpendicular to the horizontal plate and parallel to two opposite walls of the first-end section on the left and right sides, divides the horizontal plate into two equal sections to allow for an even power distribution. The tunnel within the first junction 240 includes a first chamfered turn 1440 and a first iris 1450 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The first junction 240 may be integrated in the feed network 120 as they are manufactured and formed together.

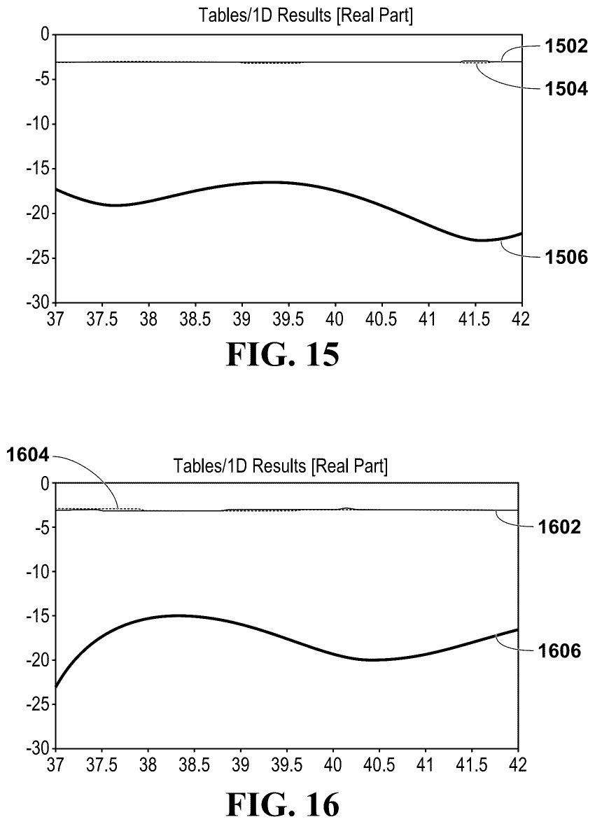

FIGS. 15 and 16 present simulation graphs illustrating the performance of the first splitter 1430 as shown in FIG. 14, for vertical and horizontal polarizations, respectively. In each figure, the vertical axis represents power attenuation in decibels relative to the incoming wave at the first-end port, while the horizontal axis represents frequency in GHz.

In FIG. 15, the power distribution between the left split wave (represented by curve 1502) and the right split wave (represented by curve 1504) is nearly identical for the vertical polarization, indicating balanced splitting. Additionally, the returning wave, which reflects back from the first splitter 1430, exhibits a power attenuation of approximately 16 to 23 dB, as represented by curve 1506.

Similarly, FIG. 16 shows that the power distribution between the left split wave (represented by curve 1602) and the right split wave (represented by curve 1604) is also nearly identical for the horizontal polarization. The returning wave for the horizontal polarization, reflected from the first splitter 1430, is attenuated by approximately 15 to 23 dB, as represented by curve 1606. These results demonstrate the first splitter's 1430 effectiveness in providing consistent power distribution for both polarizations, while also ensuring significant attenuation of any reflected waves.

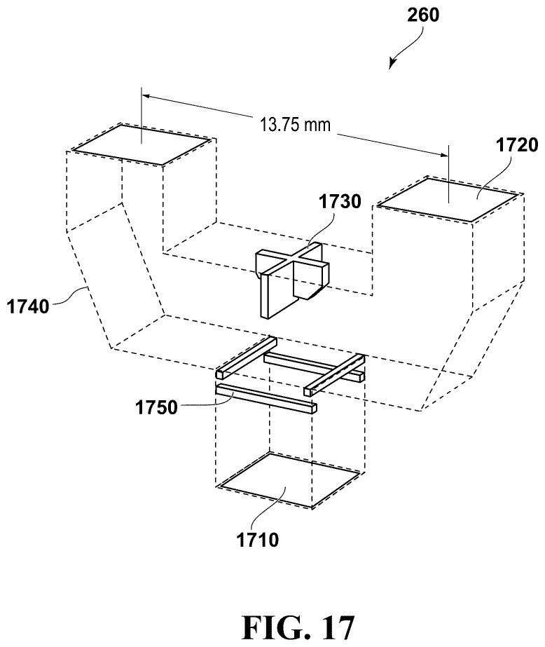

FIG. 17 illustrates the third junction 260 as one of the third stages (in the radiation direction) of the feed network 120 shown in FIG. 2. The third junction 260 is structured as a T-shaped manifold, featuring a third first-end port 1710 and two third second-end ports 1720. In this example, the distance between the centers of the two third second-end ports 1720 is 13.75 mm. Positioned within the third junction 260 is a third splitter 1730, configured as an equal power splitter. The overlap between the horizontal and vertical plates of the third splitter 1730 forms an elongate block, which faces the third first-end port 1710 and aligns coaxially with the longitudinal axis of the first-end section of the junction. The horizontal plate of the third splitter 1730 extends perpendicularly to the first-end section of the junction and is oriented to extend into the second-end section of the third junction 260. The vertical plate of the third splitter 1730, which is perpendicular to the horizontal plate and parallel to two opposite walls of the first-end section on the left and right sides, divides the horizontal plate into two equal sections to allow for an even power distribution. The tunnel within the third junction 260 includes a third chamfered turn 1740 and a third iris 1750 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The third junction 260 may be integrated in the feed network 120 as they are manufactured and formed together.

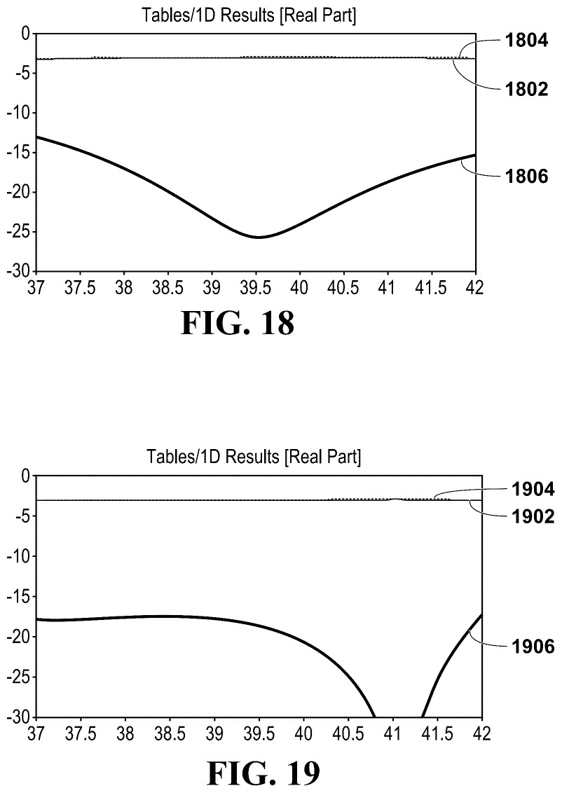

FIGS. 18 and 19 present simulation graphs illustrating the performance of the third splitter 1730 as shown in FIG. 17, for vertical and horizontal polarizations, respectively. In each figure, the vertical axis represents power attenuation in decibels relative to the incoming wave at the first-end port, while the horizontal axis represents frequency in GHz.

In FIG. 18, the power distribution between the left split wave (represented by curve 1802) and the right split wave (represented by curve 1804) is nearly identical for the vertical polarization, indicating balanced splitting. Additionally, the returning wave, which reflects back from the third splitter 1730, exhibits a power attenuation of approximately 13 to 26 dB, as represented by curve 1806.

Similarly, FIG. 19 shows that the power distribution between the left split wave (represented by curve 1902) and the right split wave (represented by curve 1904) is also nearly identical for the horizontal polarization. The returning wave for the horizontal polarization, reflected from the third splitter 1730, is attenuated by approximately 17 to more than 30 dB, as represented by curve 1906. These results demonstrate the third splitter's 1730 effectiveness in providing consistent power distribution for both polarizations, while also ensuring significant attenuation of any reflected waves.

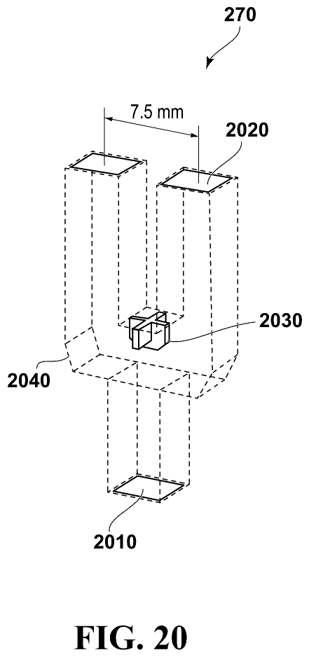

FIG. 20 illustrates the fourth junction 270 as one of the third stages (in the radiation direction) of the feed network 120 shown in FIG. 2. The fourth junction 270 is structured as a Y-shaped manifold (the second-end section turns upward shortly after the horizontal extension, hence the Y shape), featuring a fourth first-end port 2010 and two fourth second-end ports 2020. In this example, the distance between the centers of the two fourth second-end ports 2020 is 7.50 mm. Positioned within the fourth junction 270 is a fourth splitter 2030, configured as an equal power splitter. The overlap between the horizontal and vertical plates of the fourth splitter 2030 forms an elongate block, which faces the fourth first-end port 2010 and aligns coaxially with the longitudinal axis of the first-end section of the junction. The horizontal plate of the fourth splitter 2030 extends perpendicularly to the first-end section of the junction and is oriented to extend into the second-end section of the fourth junction 270. The vertical plate of the fourth splitter 2030, which is perpendicular to the horizontal plate and parallel to two opposite walls of the first-end section on the left and right sides, divides the horizontal plate into two equal sections to allow for an even power distribution. The tunnel within the fourth junction 270 includes a fourth chamfered turn 2040 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The fourth junction 270 may be integrated in the feed network 120 as they are manufactured and formed together.

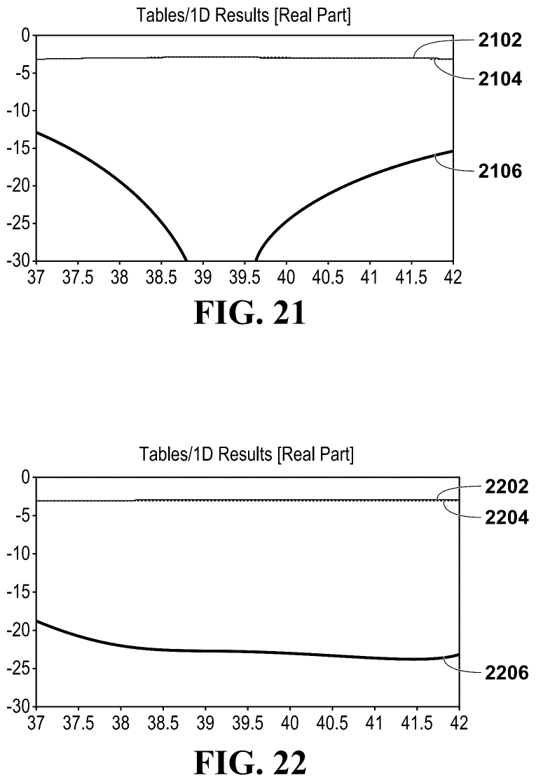

FIGS. 21 and 22 present simulation graphs illustrating the performance of the fourth splitter 2030 as shown in FIG. 20, for vertical and horizontal polarizations, respectively. In each figure, the vertical axis represents power attenuation in decibels relative to the incoming wave at the first-end port, while the horizontal axis represents frequency in GHz.

In FIG. 21, the power distribution between the left split wave (represented by curve 2102) and the right split wave (represented by curve 2104) is nearly identical for the vertical polarization, indicating balanced splitting. Additionally, the returning wave, which reflects back from the fourth splitter 2030, exhibits a power attenuation of approximately 13 to more than 30 dB, as represented by curve 2106.

Similarly, FIG. 22 shows that the power distribution between the left split wave (represented by curve 2202) and the right split wave (represented by curve 2204) is also nearly identical for the horizontal polarization. The returning wave for the horizontal polarization, reflected from the fourth splitter 2030, is attenuated by approximately 18 to 24 dB, as represented by curve 2206. These results demonstrate the fourth splitter's 2030 effectiveness in providing consistent power distribution for both polarizations, while also ensuring significant attenuation of any reflected waves.

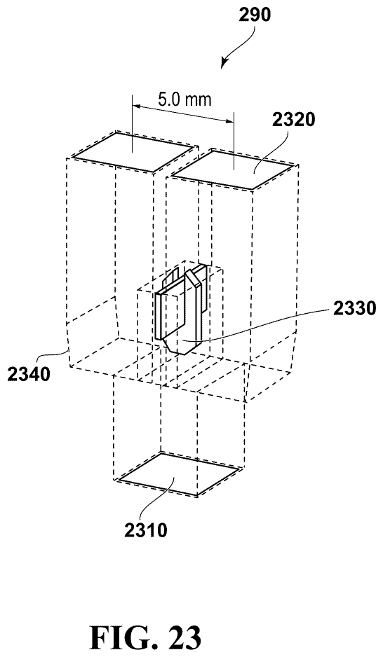

FIG. 23 illustrates the sixth junction 290 as the fifth stage (in the radiation direction) of the feed network 120 shown in FIG. 2. The sixth junction 290 is structured as a Y-shaped manifold (the second-end section turns upward shortly after the horizontal extension, hence the Y shape), featuring a sixth first-end port 2310 and two sixth second-end ports 2320. In this example, the distance between the centers of the two sixth second-end ports 2320 is 5.00 mm. Positioned within the sixth junction 290 is a sixth splitter 2330, configured as an equal power splitter. The overlap between the horizontal and vertical plates of the sixth splitter 2330 forms an elongate block, which faces the sixth first-end port 2310 and aligns coaxially with the longitudinal axis of the first-end section of the junction. The horizontal plate of the sixth splitter 2330 extends perpendicularly to the first-end section of the junction and is oriented to extend into the second-end section of the sixth junction 290. The vertical plate of the sixth splitter 2330, which is perpendicular to the horizontal plate and parallel to two opposite walls of the first-end section on the left and right sides, divides the horizontal plate into two equal sections to allow for an even power distribution. The tunnel within the sixth junction 290 includes a sixth chamfered turn 2340 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The sixth junction 290 may be integrated in the feed network 120 as they are manufactured and formed together.

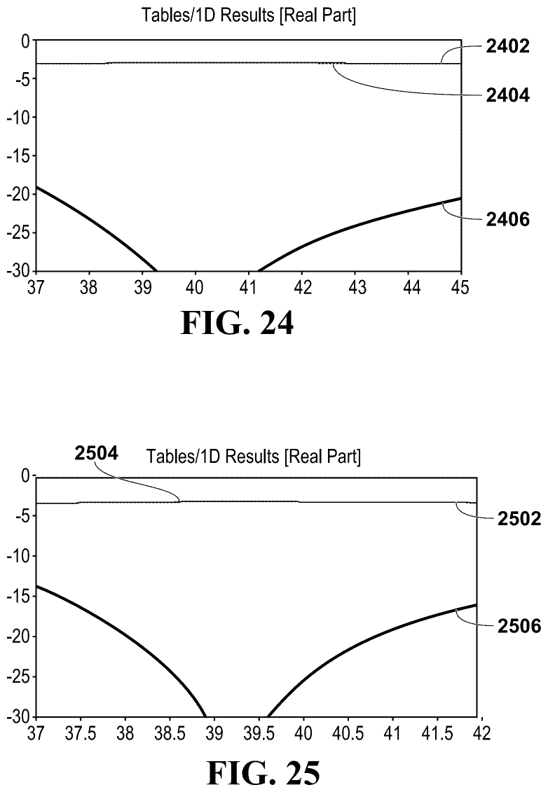

FIGS. 24 and 25 present simulation graphs illustrating the performance of the sixth splitter 2330 as shown in FIG. 23, for vertical and horizontal polarizations, respectively. In each figure, the vertical axis represents power attenuation in decibels relative to the incoming wave at the first-end port, while the horizontal axis represents frequency in GHz.

In FIG. 24, the power distribution between the left split wave (represented by curve 2402) and the right split wave (represented by curve 2404) is nearly identical for the vertical from the sixth splitter 2330, exhibits a power attenuation of approximately 19 to more than 30 dB, as represented by curve 2406.

Similarly, FIG. 25 shows that the power distribution between the left split wave (represented by curve 2502) and the right split wave (represented by curve 2504) is also nearly identical for the horizontal polarization. The returning wave for the horizontal polarization, reflected from the sixth splitter 2330, is attenuated by approximately 18 to more than 30 dB, as represented by curve 2506. These results demonstrate the sixth splitter's 2330 effectiveness in providing consistent power distribution for both polarizations, while also ensuring significant attenuation of any reflected waves.

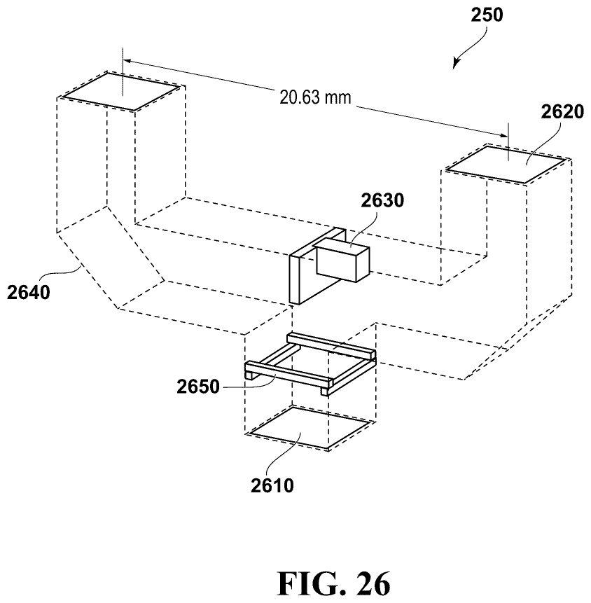

FIG. 26 illustrates the second junction 250 as the second stage (in the radiation direction) of the feed network 120 shown in FIG. 2. The second junction 250 is structured as a T-shaped manifold, featuring a second first-end port 2610 and two second second-end ports 2620. In this example, the distance between the centers of the two second second-end ports 2620 is 20.63 mm. Positioned within the second junction 250 is a second splitter 2630, configured as an unequal power splitter. The overlap between the horizontal and vertical plates of the second splitter 2630 forms an elongate block, which faces the second first-end port 2610 and is offset with the longitudinal axis of the first-end section of the junction by 2.4 mm. The horizontal plate of the second splitter 2630 extends perpendicularly to the first-end section of the junction and is oriented to extend to the right of the second-end section of the second junction 250 (in this example, the horizontal plate does not extend to the left of the vertical plate). The vertical plate of the second splitter 2630, which is perpendicular to the horizontal plate and parallel to two opposite walls of the first-end section on the left and right sides, leaves the horizontal plate with only a right section to allow for an uneven power distribution. The tunnel within the second junction 250 includes a second chamfered turn 2640 and a second iris 2650 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The second junction 250 may be integrated in the feed network 120 as they are manufactured and formed together.

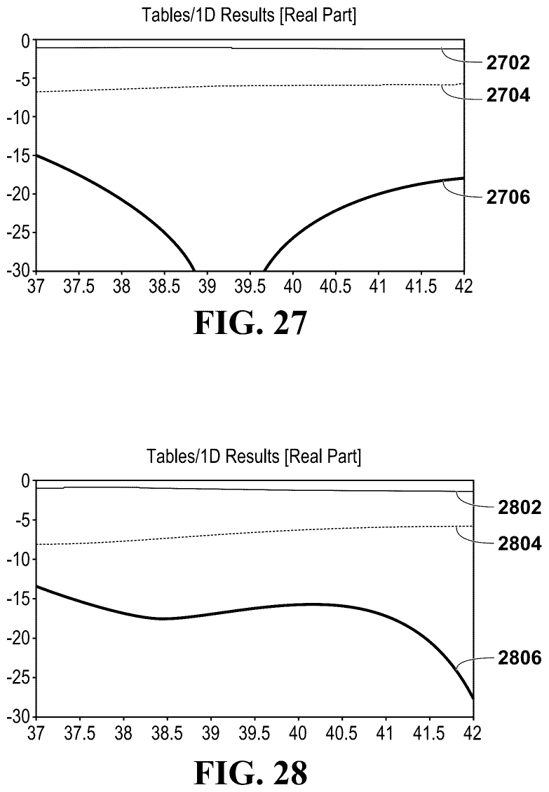

FIGS. 27 and 28 present simulation graphs illustrating the performance of the second splitter 2630 as shown in FIG. 26, for vertical and horizontal polarizations, respectively. In each figure, the vertical axis represents power attenuation in decibels relative to the incoming wave at the first-end port, while the horizontal axis represents frequency in GHz.

In FIG. 27, the power distribution between the left split wave (represented by curve 2702) and the right split wave (represented by curve 2704) is unbalanced for the vertical polarization. The left split wave experiences a power attenuation of approximately 2 dB, whereas the right split wave has a higher attenuation of approximately 6 to 7 dB. Additionally, the returning wave, which reflects back from the second splitter 2630, exhibits a power attenuation of approximately 15 to more than 30 dB, as represented by curve 2706.

Similarly, FIG. 28 shows an unbalanced power distribution for the horizontal polarization, with the left split wave (represented by curve 2802) experiencing a power attenuation of about 1 to 2 dB, while the right split wave (represented by curve 2804) is attenuated by approximately 6 to 8 dB. The returning wave for the horizontal polarization, reflected from the second splitter 2630, is attenuated by approximately 14 to 27 dB, as represented by curve 2806. These results demonstrate the functionality of the second splitter 2630, which effectively achieves customized power ratios between the split waves for both vertical and horizontal polarizations, while also attenuating reflected waves significantly.

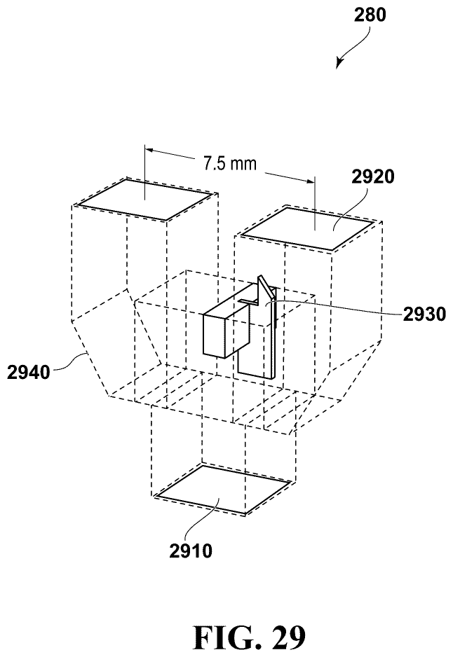

FIG. 29 illustrates the fifth junction 280 as the fourth stage (in the radiation direction) of the feed network 120 shown in FIG. 2. The fifth junction 280 is structured as a Y-shaped manifold, featuring a fifth first-end port 2910 and two fifth second-end ports 2920. In this example, the distance between the centers of the two fifth second-end ports 2920 is 7.50 mm. Positioned within the fifth junction 280 is a fifth splitter 2930, configured as an unequal power splitter. The overlap between the horizontal and vertical plates of the fifth splitter 2930 forms an elongate block, which faces the fifth first-end port 2910 and is offset with the longitudinal axis of the first-end section of the junction by 1.5 mm. The horizontal plate of the fifth splitter 2930 extends perpendicularly to the first-end section of the junction and is oriented to extend to the right of the second-end section of the fifth junction 280 (in this example, the horizontal plate does not extend to the left of the vertical plate). The vertical plate of the fifth splitter 2930, which is perpendicular to the horizontal plate and parallel to two opposite walls of the first-end section on the left and right sides, leaves the horizontal plate with only a right section to allow for an uneven power distribution. The tunnel within the fifth junction 280 includes a fifth chamfered turn 2940 to facilitate impedance matching for signal transmission.

It should be noted that the dimensions of the first-end and second-end sections in this illustration are provided as examples and are not intended to define specific requirements or imply that any portion of the feed network 120 is a standalone or isolated part. The fifth junction 280 may be integrated in the feed network 120 as they are manufactured and formed together.

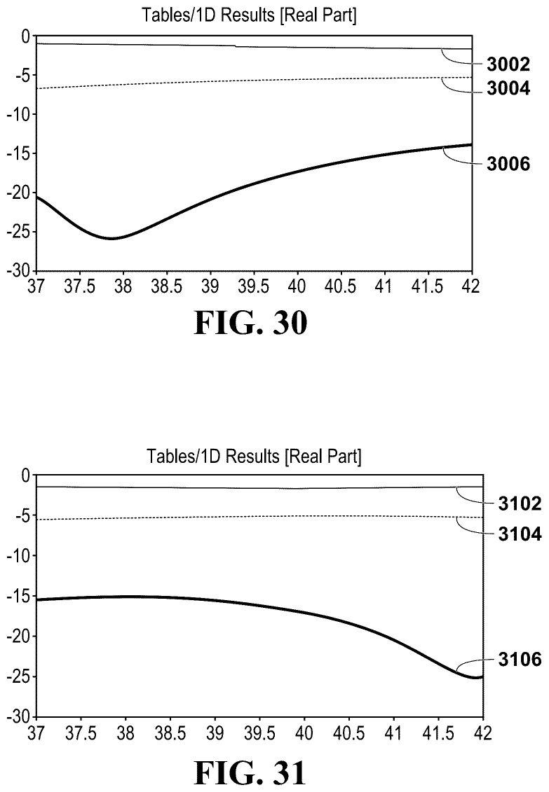

FIGS. 30 and 31 present simulation graphs illustrating the performance of the fifth splitter 2930 as shown in FIG. 29, for vertical and horizontal polarizations, respectively. In each figure, the vertical axis represents power attenuation in decibels relative to the incoming wave at the first-end port, while the horizontal axis represents frequency in GHz.

In FIG. 30, the power distribution between the left split wave (represented by curve 3002) and the right split wave (represented by curve 3004) is unbalanced for the vertical polarization. The left split wave experiences a power attenuation of approximately 1 to 2 dB, whereas the right split wave has a higher attenuation of approximately 5 to 7 dB. Additionally, the returning wave, which reflects back from the fifth splitter 2930, exhibits a power attenuation of approximately 14 to 26 dB, as represented by curve 3006.

Similarly, FIG. 31 shows an unbalanced power distribution for the horizontal polarization, with the left split wave (represented by curve 3102) experiencing a power attenuation of approximately 2 dB, while the right split wave (represented by curve 3104) is attenuated by approximately 5 to 6 dB. The returning wave for the horizontal polarization, reflected from the fifth splitter 2930, is attenuated by approximately 15 to 25 dB, as represented by curve 3106. These results demonstrate the functionality of the fifth splitter 2930, which effectively achieves customized power ratios between the split waves for both vertical and horizontal polarizations, while also attenuating reflected waves significantly.

As described above, in the feed network 120 as illustrated in FIG. 2, the structure is designed as a tree configuration, with multiple junctions positioned at various stages throughout the network. This tree-like arrangement enables each incoming electromagnetic wave to be gradually divided as it travels downstream through successive junctions, providing controlled distribution of power across the network. In this particular example, each wave fraction generally passes through at least three junctions before reaching its designated second-end aperture, allowing for refined management of wave characteristics as it propagates. It should be understood that more or fewer stages of junctions may be involved for a wave route from the first-end aperture to the second-end aperture.

In some embodiments, one or more of these junctions may be equipped with an unequal power splitter. The inclusion of unequal power splitters within the network enables tailored power ratios for specific paths, allowing for customized power distribution across the antenna array and adding flexibility to the overall design of the feed network.

The feed network 120, including its multiple junctions, equal power splitters, and unequal power splitters, can be integrally fabricated using three-dimensional (3D) printing techniques. Fabricating the components as a single integrated unit can simplify assembly, reduce manufacturing complexity, and improve alignment accuracy, which is particularly advantageous for ensuring consistent performance at high frequencies. The use of 3D printing also enables the creation of intricate geometries that would be difficult to achieve with traditional manufacturing methods. However, other manufacturing methods, such as precision machining or metal casting, may also be used depending on specific design requirements and production capabilities.

In certain implementations, the feed network 120 may be constructed from a metallic material to ensure efficient conductivity and to support the high power-handling capacity required for effective wave transmission. The metallic composition provides low-loss characteristics, minimizing signal attenuation as the electromagnetic waves traverse the network, thereby enhancing the overall efficiency and reliability of the feed network. However, other suitable materials, such as certain conductive polymers or metal-coated composites, may also be used depending on the specific requirements of the application and the desired balance between performance, weight, and cost.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A waveguide antenna apparatus, comprising:
a feed network configured to divide a first-end electromagnetic wave into wave fractions in a radiation direction for radiating in at least one of vertical and horizontal polarization modes, or to combine a plurality of second-end electromagnetic waves into a single wave in a reception direction opposite to the radiation direction, the feed network including:
a plurality of junctions, each having one first-end section and two second-end sections;
at least one equal power splitter positioned at one or more of the plurality of junctions, each of the at least one equal power splitter being symmetrically structured to divide a radiation electromagnetic wave arriving from its corresponding first-end section into two equally divided waves, or to combine two reception electromagnetic waves arriving from its corresponding second-end sections; and
at least one unequal power splitter positioned at the remaining junctions, each of the at least one unequal power splitter being asymmetrically structured to divide a radiation electromagnetic wave arriving from its corresponding first-end section into two unequally divided waves, or combine two reception electromagnetic waves arriving from its corresponding second-end sections.

2. The waveguide antenna apparatus of claim 1, further comprising:
a first-end aperture configured to feed or receive the first-end electromagnetic wave to or from an orthomode transducer (OMT); and
a plurality of second-end apertures, each configured to radiate or receive one of the plurality of second-end electromagnetic waves.

3. The waveguide antenna apparatus of claim 1, wherein the feed network has a square cross-section configured to support a transmission of dual polarization modes.

4. The waveguide antenna apparatus of claim 1, wherein the plurality of second-end apertures are distributed along a straight line.

5. The waveguide antenna apparatus of claim 1, wherein each of the at least one equal power splitter comprises a horizontal plate and a vertical plate perpendicular to the horizontal plate, forming a cross-shaped cross section, wherein the horizontal plate is divided by the vertical plate into a left part and a right part of a same length, and wherein an overlap between the horizontal plate and the vertical plate forms an elongate block that is coaxially aligned with a longitudinal axis of the first-end section.

6. The waveguide antenna apparatus of claim 5, wherein the first-end section has a square-shaped cross section, wherein the horizontal plate is parallel to two opposite surfaces of the first-end section, and wherein the left and right parts of the horizontal plate extend into the two second-end sections.

7. The waveguide antenna apparatus of claim 6, wherein each of the plurality of junctions in the feed network is shaped as a T-shaped manifold, and wherein the two second-end sections are coaxially oriented with each other and are perpendicular to the first-end section.

8. The waveguide antenna apparatus of claim 4, wherein an iris is positioned in the first-end section.

9. The waveguide antenna apparatus of claim 4, wherein each of the at least one unequal power splitter comprises a horizontal plate and a vertical plate perpendicular to the horizontal plate, wherein the horizontal plate is positioned on at least one side of the vertical plate, and wherein an overlap between the horizontal plate and the vertical plate forms an elongate block that is parallel to the longitudinal axis of the first-end section.

10. The waveguide antenna apparatus of claim 9, wherein the first-end section has a square-shaped cross section, wherein the horizontal plate is parallel to two opposite surfaces of the first-end section, and wherein the horizontal plate extends into at least one of the two second-end sections.

11. The waveguide antenna apparatus of claim 10, wherein the horizontal plate is divided by the vertical plate into a left part and a right part of different lengths.

12. The waveguide antenna apparatus of claim 11, wherein the overlap between the horizontal plate and the vertical plate is offset from the longitudinal axis of the first-end section.

13. The waveguide antenna apparatus of claim 10, wherein each of the plurality of junctions in the feed network is shaped as a T-shaped manifold, and wherein the two second-end sections are coaxially oriented with each other and are perpendicular to the first-end section.

14. The waveguide antenna apparatus of claim 9, wherein an iris is positioned in the first-end section.

15. The waveguide antenna apparatus of claim 1, wherein the feed network is a tree structure and the plurality of junctions are provided at different stages of the tree structure, such that each of the wave fractions passes through at least three junctions before reaching the corresponding one of the plurality of second-end apertures.

16. The waveguide antenna apparatus of claim 15, wherein at least one of the at least three junctions is provided with an unequal power splitter.

17. The waveguide antenna apparatus of claim 1, wherein the plurality of junctions, the at least one equal power splitter, and the at least one unequal power splitter are integrally fabricated by three-dimensional (3D) printing.

18. The waveguide antenna apparatus of claim 1, wherein the feed network is made of a metallic material.

19. A method of radiating electromagnetic waves through a waveguide antenna apparatus, the method comprising:
receiving a first-end electromagnetic wave at a first end of the waveguide antenna apparatus;
directing the first-end electromagnetic wave into a feed network of the waveguide antenna apparatus, the feed network configured to divide the first-end electromagnetic wave into wave fractions in a radiation direction for radiating at a second end of the waveguide antenna apparatus, wherein the feed network comprises a plurality of junctions, each having one first-end section and two second-end sections;
dividing the first-end electromagnetic wave into the wave fractions using at least one equal power splitter and at least one unequal power splitter,
wherein the at least one equal power splitter is positioned at one or more of a plurality of junctions in the feed network and symmetrically structured to divide a radiation electromagnetic wave arriving from its corresponding first-end section into two equally divided waves, and
wherein the at least one unequal power splitter is positioned at the remaining junctions and asymmetrically structured to divide a radiation electromagnetic wave arriving from its corresponding first-end section into two unequally divided waves; and
directing each of the wave fractions to the second end of the waveguide antenna apparatus for radiation in at least one of vertical and horizontal polarization modes.

20. A communication system comprising:
a waveguide antenna apparatus, comprising:
a plurality of feed networks stacked with each other, each configured to divide a first-end electromagnetic wave into wave fractions in a radiation direction for radiating in at least one of vertical and horizontal polarization modes, each of the plurality of feed networks including:
a plurality of junctions, each having one first-end section and two second-end sections;
at least one equal power splitter positioned at one or more of the plurality of junctions, each of the at least one equal power splitter being symmetrically structured to divide a radiation electromagnetic wave arriving from its corresponding first-end section into two equally divided waves; and
at least one unequal power splitter positioned at the remaining junctions, each of the at least one unequal power splitter being asymmetrically structured to divide a radiation electromagnetic wave arriving from its corresponding first-end section into two unequally divided waves;
a plurality of orthomode transducers (OMTs), each connected to a respective one of the plurality of feed networks, wherein each of the plurality of OMTs is configured to receive and transmit dual orthogonally polarized electromagnetic waves; and
a pair of beamforming devices, each having a corresponding number of outlets coupled to the plurality of OMTs to supply the radiation electromagnetic wave of a specific polarization to the plurality of OMTs.
